(19) United States
(12) Patent Application Publication
(10) Pub. No.: US 2004/0108165 A1
(43) Pub. Date: Jun. 10, 2004

(54) ADJUSTABLE HUNTING TREE STAND

(76) Inventors: Austin Poole, Jackson, MS (US); William VanDevender, Jackson, MS (US)

Correspondence Address: MCGARRY BAIR PC, 171 MONROE AVENUE, N.W., SUITE 600, GRAND RAPIDS, MI, 49503, US

(21) Appl. No.: 10/604,435

(22) Filed: Jul. 21, 2003

Related U.S. Application Data
(60) Provisional application No. 60/319,482, filed on Aug. 21, 2002.
(60) Provisional application No. 60/319,565, filed on Sep. 20, 2002.

(51) Int. Cl. A01M 31/00

(52) U.S. Cl. 182/136

(57) ABSTRACT

A tree climbing hunting stand comprises a planar frame having an attitude adjuster, including a pair of articulating support arms in contact with the tree. The hunting stand is suspended from a tree by elevating the support arms to encircle the tree and adjusting the attitude adjuster to position the frame at a selected attitude. A ratchet assembly, telescoping arm assembly, or pin assembly is used to selectively adjust the attitude of the planar frame to accommodate trees of differing diameters.

### CROSS REFERENCE TO RELATED APPLICATIONS

This application claims the benefit of U.S. provisional applications Serial No. 60/319,482, filed Aug. 21, 2002, and 60/319,565, filed Sep. 20, 2002, which are incorporated herein in their entirety.

### BACKGROUND OF INVENTION

1. Field of the Invention

The invention relates to elevated platforms. In one aspect, the invention relates to an elevated platform with opposed articulating arms attached to a tree for use as a hunting blind. In another aspect, the invention relates to an elevated platform comprising an adjustable leveling apparatus.

2. Description of the Related Art

Hunters frequently prefer to hunt from an elevated position. Elevation enables the hunter to more easily avoid detection by his or her prey, provides an improved field of vision, and can provide an unimpeded shot once the prey has come within range.

Tree stands have been developed comprising one or more platforms that can be mounted to a tree. One type of tree stand comprises two movable platforms attached to an assembly that encircles the tree and enables the user to climb the tree by alternately raising each platform and supporting the user's weight on one platform while the second platform is raised or lowered to another position. However, suspending these “climbing” tree stands and adjusting them to adapt to trees of differing diameters can be noisy, thereby scaring away the hunter's prey. Furthermore, many of the diameter-adjustment mechanisms are complex and can require arm and hand strength, dexterity, and flexibility, which the hunter may not possess. Most climbing tree stands are not readily adjustable to accommodate changes in the tree diameter as the user climbs the tree. Unless the tree stand is adjustable to accommodate a smaller tree diameter once the tree stand has been suspended in the tree, the platforms will be positioned at an angle from the horizontal, causing instability and the risk of a fall.

Climbing tree stands typically have an attachment piece that connects the tree stand on the side of the tree opposite the platform in order to fasten the platform to the tree. Typically, the hunter must hold the platform to the tree and reach behind a tree with a movable V-bar or cable, attaching both ends of the V-bar or cable to the platform with pins, bolts, or other connectors. It can be difficult to hold the platform while attempting to manipulate the various components of the tree stand in order to suspend the tree stand from the tree. It can also generate undesirable noise. The component parts can be improperly assembled, causing potential injury. As well, small parts such as pins or bolts can be lost or misplaced rendering the tree stand inoperable. Finally, component parts can become rusted or ice covered in frigid temperatures, thereby complicating their use.

The few tree stands, which can be adjusted typically, utilize an adjustment of the V-bars or cables to accommodate different tree diameters. Some adjustments may involve pins, bolts or other connectors. One adjustment mechanism comprises a T-bar that is attached to the V-bar or cable on the side of the tree opposite the platform and is turned by hand. The adjustment can only be accomplished if the hunter faces the tree and then reaches around the tree to turn the T-bar. This operation will typically not be visible to the hunter. Another technique includes using a wooden wedge between the tree and the suspension mechanism to level the platform. This also can be difficult and exposes the hunter to the risk of injury.

### SUMMARY OF INVENTION

In one aspect, the invention relates to an adjustable elevated hunting stand for supporting a person a spaced distance from the ground relative to a vertical structure, comprising: a first platform comprising a first frame having a first member adapted for compressive register with the vertical structure, and at least one second member attached to the first frame and adapted for tensile register with the vertical structure; a second platform comprising a second frame having a first member adapted for compressive register with the vertical structure, and at least one second member attached to the second frame and adapted for tensile register with the vertical structure; at least one of the first and second platforms including an attitude adjuster interposed between the at least one of the first and second frames and the vertical structure, wherein the person can adjust the planar alignment of the at least one of the first and second frames relative to the vertical structure when the person is supported on the adjustable elevated hunting stand.

Various embodiments of the invention are also contemplated. The first member can be moveable relative to the at least one of the first and second frames. The attitude adjuster can comprise a ratchet for moving the first member relative to the at least one of the first and second frames. The at least one second member can comprise two support arms. The two support arms can extend around at least a portion of a perimeter of the vertical structure. The two support arms can be adapted for locking communication around at least a portion of the perimeter of the vertical structure.

The attitude adjuster can comprise a telescoping portion comprising part of the at least one second member. The at least one second member can be pivotally attached to the at least one of the first and second frames.

In another aspect, the invention relates to an adjustable elevated hunting stand for supporting a person a spaced distance from the ground relative to a vertical structure, comprising: a first platform adapted to support a person in a standing position; a second platform adapted to support a person in a seated position; at least one of the first and second platforms including an attitude adjuster interposed between the at least one of the first and second platforms and the vertical structure, wherein the person can adjust the planar alignment of the at least one of the first and second platforms relative to the vertical structure when the person is supported on the adjustable elevated hunting stand.

Various embodiments of this aspect of the invention are also contemplated. The attitude adjuster can comprise a ratchet for moving at least one of the first and second platforms relative to the vertical structure. The attitude adjuster can comprise at least one member attached to the at least one of the first and second platforms and the vertical structure, and can be adapted for telescoping adjustment of the length of said at least one member.

In an additional aspect, the invention relates to an adjustable elevated hunting stand for supporting a person a spaced distance from the ground relative to a vertical structure, comprising: at least one platform adapted for at least one of seated and standing support of a user when occupying the hunting stand the spaced distance from the ground relative to a vertical structure.

The at least one platform can comprise: a first member having an inner surface adapted for compressive register with the vertical structure; a second member having an inner surface adapted for tensile register with the vertical structure, wherein the inner surface of the first member and the inner surface of the second member cooperate to define a selectable distance therebetween; and an adjustable mounting between the first and second members, wherein the adjustable mounting between the first and second members allows for adjustment of the selectable distance between the respective inner surfaces. Vertical structures having varying perimeters can thereby be accommodated by selective adjustment of the selectable distance.

Various embodiments of this aspect of the invention are also contemplated. The at least one platform can comprise a first platform adapted for seated support of a user when occupying the hunting stand and a second platform adapted for standing support of a user when occupying the hunting stand. The first member can be moveable relative to the second member. The adjustable mounting between the first and second members can comprise a ratchet for moving the first member relative to the second member. The second member can comprise two support arms. The two support arms can extend around at least a portion of a perimeter of the vertical structure. The support arms can be adapted for locking communication around at least a portion of the perimeter of the vertical structure. The adjustable mounting can comprise a telescoping portion wherein one of the first and second members is received within the other of the first and second members. The at least one second member can be pivotally attached to the first member.

### BRIEF DESCRIPTION OF DRAWINGS

In the drawings:

FIG. 1 is a perspective view of a tree with an adjustable hunting tree stand attached thereto according to the invention.

FIG. 2 is a perspective view of a standing platform comprising a first portion of the adjustable hunting tree stand of FIG. 1.

FIG. 3 is a perspective view of a seat platform comprising a second portion of the adjustable hunting tree stand of FIG. 1.

FIG. 4 is an exploded view of the standing platform of FIG. 2.

FIG. 5 is a close-up perspective view of a portion of the adjustable hunting tree stand of FIG. 1.

FIG. 6 is a close-up perspective view of a hinge assembly forming a portion of the adjustable hunting tree stand of FIG. 1.

FIG. 7A is a plan view of a frame forming a portion of the standing platform of FIG. 2.

FIG. 7B is a plan view of an arm assembly forming a portion of the standing platform of FIG. 2.

FIG. 8A is a plan view of a frame forming a portion of the seat platform of FIG. 3.

FIG. 8B is a plan view of an arm assembly forming a portion of the seat platform of FIG. 3.

FIG. 9A is a perspective view of the standing platform portion of the adjustable hunting tree stand of FIG. 1 in preparation for attaching the adjustable hunting tree stand to a tree.

FIG. 9B is a perspective view of the standing platform portion of the adjustable hunting tree stand of FIG. 8A in the process of being attached to the tree.

FIG. 9C is a first perspective view of the standing platform portion of the adjustable hunting tree stand of FIG. 8A attached to the tree.

FIG. 9D is a second perspective view of the standing platform portion of the adjustable hunting tree stand of FIG. 9C attached to the tree.

FIG. 10 is a plan view of the standing platform of FIG. 2 suspended from a tree having a first diameter.

FIG. 11 is a plan view of the standing platform of FIG. 2 suspended from a tree having a second diameter.

FIG. 12 is a plan view of a frame forming a portion of a seat platform comprising a first alternative adjustment mechanism.

FIG. 13 is a close-up perspective view of the first alternative adjustment mechanism shown in FIG. 12.

FIG. 14 is a plan view of a frame forming a portion of a seat platform comprising a second alternative adjustment mechanism.

FIG. 15 is a perspective view of a third embodiment of a tree stand comprising a standing platform and a seat platform attached to a tree through an extendable support arm assembly.

FIG. 16 is a perspective view of the standing platform shown in FIG. 15.

FIG. 17 is a perspective view of the seat platform shown in FIG. 15.

FIG. 18 is a close-up plan view of a portion of the extendable support arm assembly shown in FIG. 15.

FIG. 19 is a perspective view of the seat platform shown in FIG. 15 with the extendable support arm assembly positioned for suspending the seat platform from the tree.

### DETAILED DESCRIPTION

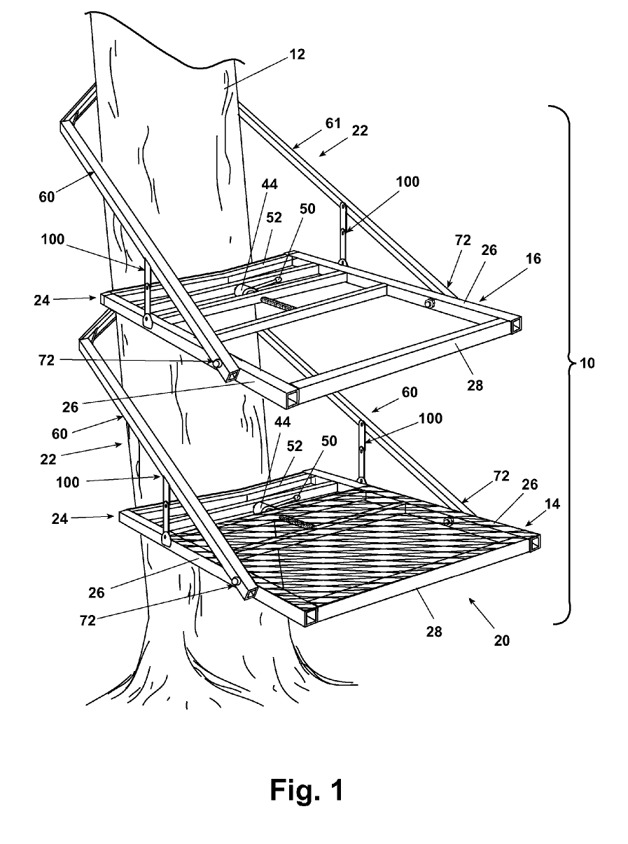

FIG. 1 shows a tree 12 to which is suspended a first embodiment of a two-part adjustable hunting tree stand 10 according to the invention for supporting a hunter thereon in an elevated position. The tree stand 10 is similar in many respects to a conventional tree stand known in the industry as a “climbing” tree stand, and is suspended from a tree and used in a manner similar to a conventional climbing tree stand. The tree stand 10 comprises a standing platform 14, on which the hunter stands, and a seat platform 16, on which the hunter can sit.

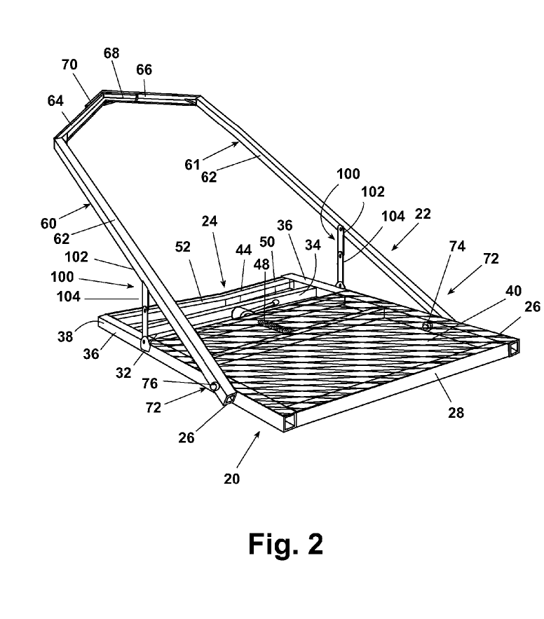

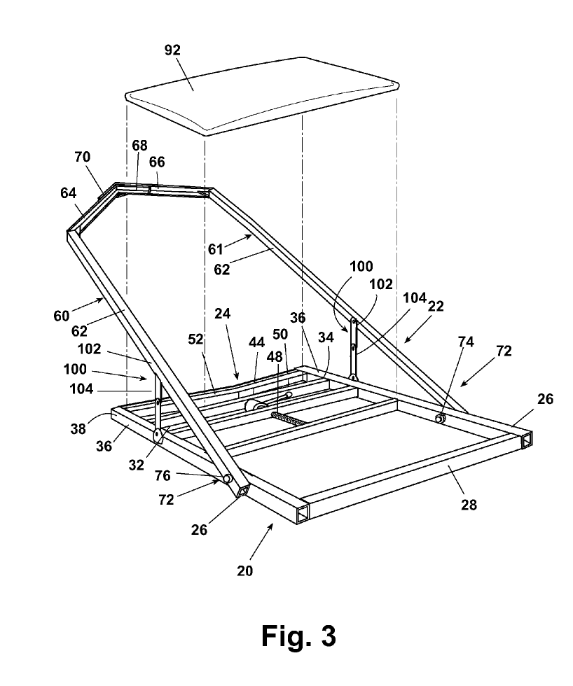

FIG. 2 shows the standing platform 14 assembled for suspension from a tree (not shown), and FIG. 3 shows the seat platform 16 assembled for suspension from a tree (not shown). The standing platform 14 and the seat platform 16 are identical in most respects, and like numbers are used to identify like parts in each. The following description of the structure and operation of the standing platform 14 is the same as for the seat platform 16, except where otherwise noted.

Referring now to FIGS. 1, 2, 4, 7A and 7B, the standing platform 14 comprises a floor frame 20, an arm assembly 22, and a V-brace assembly 24. The floor frame 20 is a generally rectangular planar frame comprising a pair of parallel, spaced-apart side frame members 26 rigidly connected by an outer cross frame member 28, an intermediate cross frame member 30, a ratchet cross frame member 32, an inner cross frame member 34, and a V-cross frame member 52 in spaced-apart, parallel juxtaposition orthogonal to the side frame members 26. In the preferred embodiment, the frame members 26-34, 52 comprise structural steel tubing having a rectilinear, preferably square, cross section of suitable structural properties for the purposes described herein. The frame members 26-34 comprise straight lengths of tubing. The V-cross frame member 52 comprises a generally V-shaped member opening away from the interior of the floor frame 20. The members 26-34, 52 are joined by welding or other suitable conventional fastening methods, such as threaded connectors, to provide a frame 20 having sufficient strength and rigidity for the purposes described herein. Additional cross frame members (not shown) can be utilized to provide additional strength and rigidity to the frame 20.

The side frame members 26 are provided at an intermediate point with coaxially-aligned side frame pivot pins 122. The pivot pins 122 are preferably threaded, bolt-like fasteners that are welded to the side frame members 26 and adapted to receive mating threaded nuts 120 thereon. Intermediate the outer cross frame member 28 and the intermediate cross frame member 30, side frame member apertures 86 extend through the side frame members 26 in coaxial alignment for pivotable attachment of the arm assembly 22 as hereinafter described.

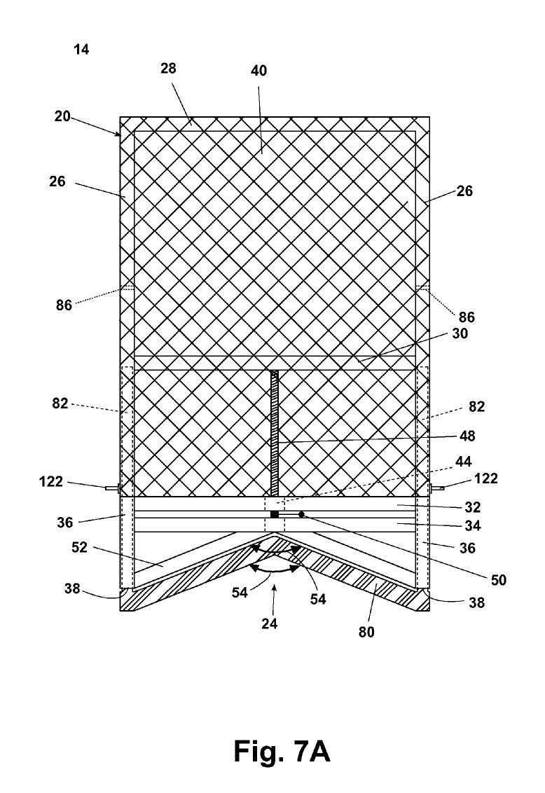

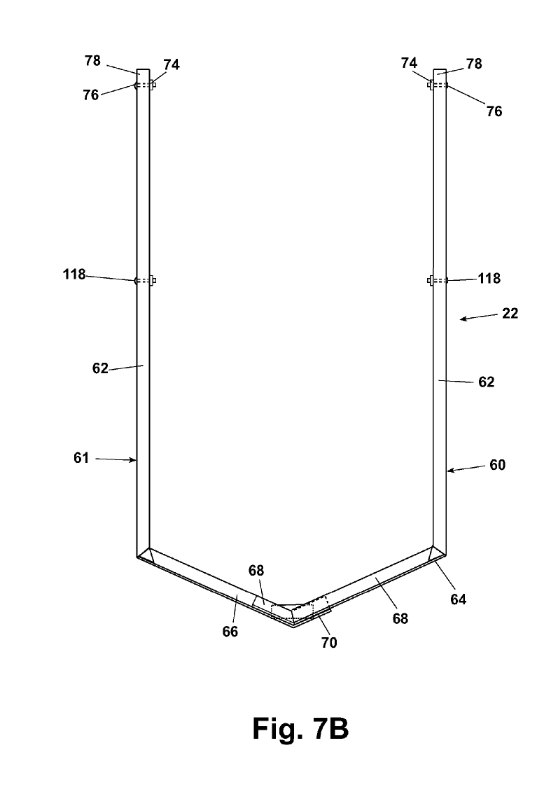

Attached to the members 26-34 is a floor 40, preferably comprising a structural steel mesh. The floor 40 is fixedly attached to the floor frame 20, preferably by welding along the members 26-34 around the perimeter of the mesh floor 40. As shown in FIG. 7A, the floor 40 extends from the outer cross frame member 28 to the ratchet cross frame member 32.

The side frame members 26 terminate in a first end 36 having a channelway 38 extending longitudinally into the side member 26 from the free end 36 for receipt of the V-brace assembly 24 as hereinafter described.

The arm assembly 22 comprises a first support arm 60 and a second support arm 61, each of which is pivotably attached at a pivot end 78 to the side frame members 26 through a pivot assembly 72, and at an intermediate point through a hinge assembly 100. The support arms 60, 61 comprise a pair of elongated, parallel, spaced-apart pivoting members 62 comprising structural steel tubing having a rectilinear, preferably square, cross section of suitable structural properties for the purposes described herein. The pivot end 78 has a pivot member aperture 84 therethrough. The first support arm 60 terminates in a first hooking member 64. The second support arm 61 terminates in a second hooking member 66. The first hooking member 64 terminates in a hooking end 68. The second hooking member 66 terminates in a hooking sleeve 70. Intermediate the pivot ends 78 and the hooking members 64, 66 are coaxially-aligned hinge apertures 88 extending through the pivoting members 62 for pivotable attachment of a hinge assembly as hereinafter described.

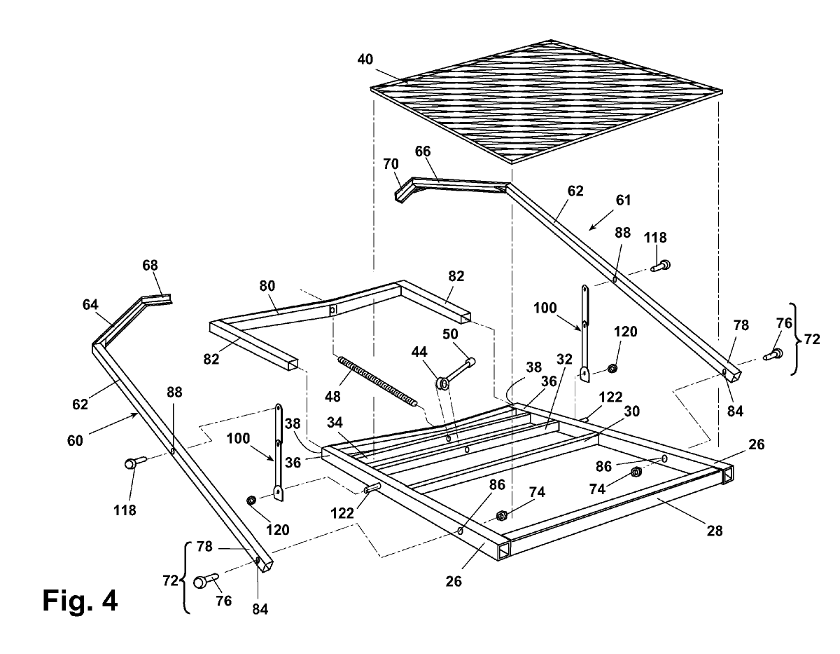

The hooking members 64, 66 preferably comprise steel angle having suitable structural properties for the purposes described herein and are preferably welded to the pivot members 62 at a generally obtuse angle as shown in FIGS. 4, 7B, and 8B. The hooking sleeve 70 is preferably steel angle of the same cross section as the hooking member 66, and is welded to the hooking member 66 at a generally obtuse angle as shown in FIGS. 4, 7B, and 8B.

The pivoting members 62 are pivotably attached to floor frame 20 through a pair of pivot assemblies 72 so that the hooking members 64, 66 extend toward the V-brace assembly 24. The pivot assembly 72 comprises a pivot fastener 76 passing through the pivot member aperture 84 and the side frame member aperture 86 and secured thereto with a pivot nut 74. The pivot fastener 76 comprises a suitable pin-type fastener, such as a threaded bolt or a pin with a cotter key.

Referring now to FIG. 6, the hinge assembly 100 comprises an upper arm 102 pivotably attached to a lower arm 104. The upper arm 102 and the lower arm 104 comprise generally conventional elongated, bar-like members pivotably attached through an intermediate pivot assembly 110. In the preferred embodiment, the intermediate pivot assembly 110 comprises a generally conventional pin-type assembly for securely attaching the upper arm 102 to the lower arm 104 while allowing relative rotation of the arms 102,104. The upper arm 102 is provided with an upper pivot aperture 108 at a first end and a locking detent 116 at a second end. In the preferred embodiment, the locking detent 116 comprises a semicircular-shaped depression. The lower arm 104 is provided with a lower pivot aperture 112 at a first end and a locking boss 114 intermediate the pivot aperture 112 and the intermediate pivot assembly 110. The locking boss 114 comprises a semicircular-shaped protrusion of a size and shape suitable for mating communication with the locking detent 116. The upper arm 102 is pivotably attached to the pivoting members 62 by an upper pivot pin 118 passing through the upper pivot aperture 108 and the hinge aperture 88. The lower arm 104 is pivotably attached to the side frame member 26 by inserting the side frame pivot pin 122 through the lower pivot aperture 112 and pivotably securing the lower arm 104 thereon by the nut 120. When the support arms 60 are rotated away from the floor frame 20 the hinge assembly 100 will extend so that the upper arm 102 and the lower arm 104 are in longitudinal alignment, and the locking boss 114 will be received in the locking detent 116 to lock the hinge assembly 100 in a linear alignment.

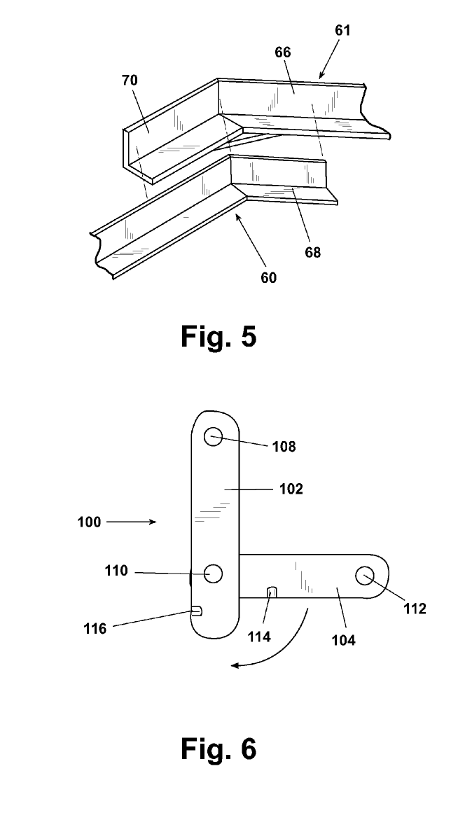

The support arms 60, 61 can be independently pivoted. For example, the first support arm 60 can be rotated upwardly while the second support arm 61 remains folded against a side frame member 26. The second support arm 61 can be rotated upwardly to be joined to the first support arm 60 by nesting the hooking end 68 into the second hooking member 66 and enclosing the hooking sleeve 70 around the first hooking member 64, as shown in FIG. 5. The locking of the hinge assemblies 100 in the extended position will retain the support arms 60, 61 in operable juxtaposition and will help retain the hooking end 68 and the hooking sleeve 70 in position relative to the hooking members 66, 64, respectively.

The V-brace assembly 24 comprises an adjustment member 80 and a pair of parallel, spaced-apart sliding arms 82 (see, e.g., FIG. 7A). The adjustment member 80 is a generally V-shaped member of structural steel tubing having a rectilinear, preferably square, cross section of suitable structural properties for the purposes described herein. The vertex of the adjustment member 80 is oriented toward the inner cross frame member 34. The sliding arms 82 are rigidly attached to each end of the adjustment member 80 and comprise structural steel tubing having a cross section of suitable structural properties for the purposes described herein and adapted to be slidably received in the channelways 38. Preferably, the sliding arms 82 are attached to the adjustment member 80 by welding to form a rigid, generally planar assembly. The V-brace assembly 24 and the floor frame 20 form a generally planar assembly when the sliding arms 82 are inserted into the channelways 38.

A threaded rod 48 is rigidly attached to the vertex of the adjustment member 80, such as by welding, to extend from the vertex of the adjustment member 80 in parallel, spaced-apart juxtaposition with the sliding arms 82. A conventional ratchet assembly 44 having a ratchet handle 50 is adapted for axial movement of the threaded rod 48 along the ratchet assembly 44. The ratchet assembly 44 is attached to the floor frame 20 in a conventional manner for movement of the V-brace assembly 24 relative to the floor frame 20 as the threaded rod 48 is moved by operation of the ratchet assembly 44. The ratchet assembly 44 can be operated to selectively move the V-brace assembly 24 toward or away from the floor frame 20. Bearings (not shown) can be attached to the frame members 32, 34, 52 for support and alignment of the threaded rod 48.

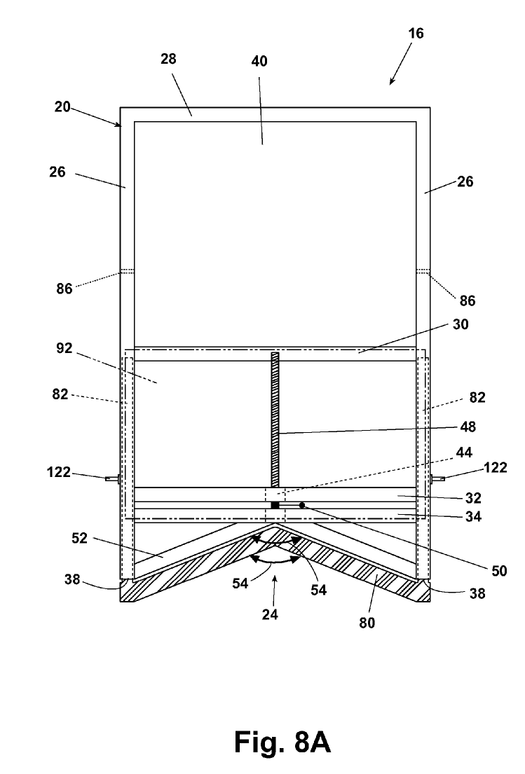

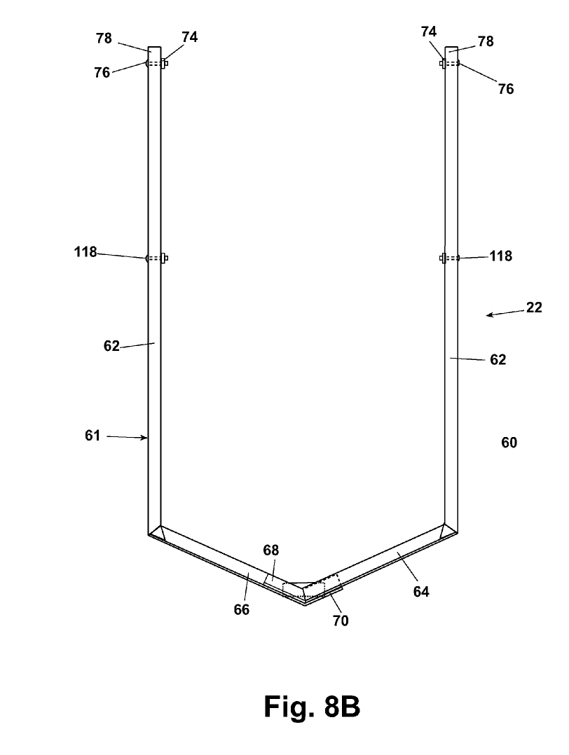

Referring to FIG. 8A, the seat platform 16 is identical to the standing platform 14 except that the frame members 28-34, 52 and the adjustment member 80 of the seat platform 16 are shortened so that that the seat platform 16 can be stacked onto the standing platform 14 with the side frame members 26 of the seat platform 16 bracketed by the pivot assemblies 72 and support arms 60 of the standing platform 14. Additionally, the seat platform 16 has no floor 40, and a seat 92 can be supported over the area bounded by the intermediate cross frame member 30 and the ratchet cross frame member 32 as shown in FIG. 3.

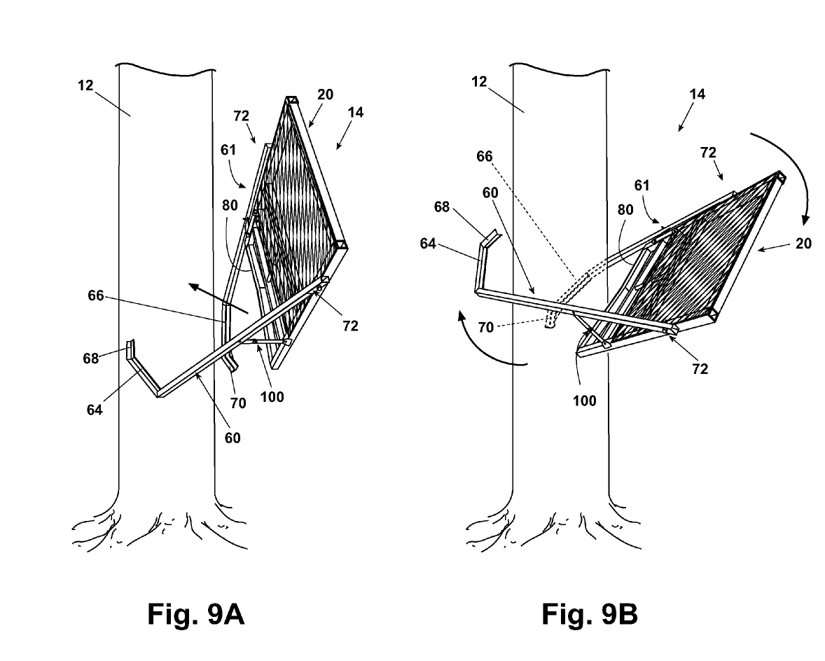

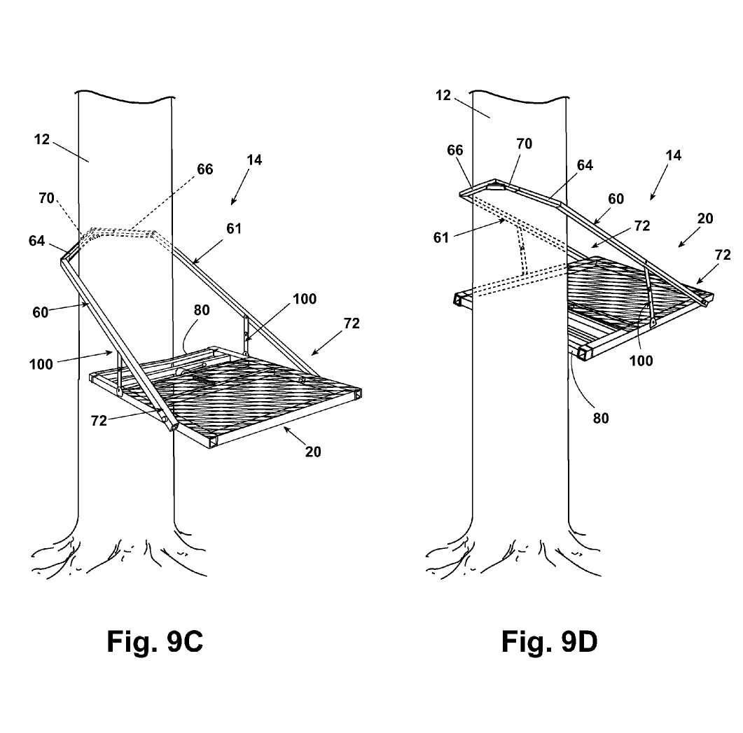

Referring now to FIGS. 9A-D, the tree stand 10 is attached to a tree 12 and progressively “walked” up the tree in a fashion similar to a conventional tree climber hunting stand. FIGS. 9A-D show the steps taken in suspending the standing platform 14 from the tree 12. Similar steps are taken in suspending the seat platform 16 from the tree 12. However, the tree stand 10 is adapted so that the seat platform 16 can be “stacked” onto the standing platform 14 so that both components 14, 16 can be suspended from the tree 12 in unison in a single operation. The following exemplary description will address the steps taken in suspending the standing platform 14.

As shown in FIG. 9A, the standing platform 14 is suspended from the tree by first raising the first support arm 60 and locking the hinge assembly 100 in the fully extended position. The second support arm 61 remains folded against the floor frame 20. The standing platform 14 is oriented so that the floor frame 20 is essentially vertical and the support arms 60, 61 straddle the tree 12. It is anticipated that the adjustment member 80 will be brought into or almost into contact with the tree 12. The standing platform 14 is then rotated so that the floor frame 20 assumes an essentially horizontal position with the first hooking member 64 and the second hooking member 66 positioned around the tree 12 opposite the floor frame 20. As shown in FIG. 9C, the second support arm 61 is then raised and the hinge assembly 100 is locked in a fully extended position. The hooking finger 68 is nested into the second hooking member 66 and the hooking sleeve 70 is enclosed around the first hooking member 64 so that the support arms 60, 61 are locked together (FIGS. 5 and 9D). The standing platform 14 will then be suspended from the tree 12, as shown in FIG. 9C, with the hooking members 64, 66 and the adjustment member 80 in contact with the tree 12. The seat platform 16 is suspended from the tree 12 in an identical fashion. The tree stand 10 is then “stepped” up the tree 12 by the hunter as for a conventional tree climber.

Alternatively, both the standing platform 14 and the seat platform 16 can be suspended from the tree in a single operation by first stacking the seat platform 16 onto the standing platform 14. The pair of first support arms 60 are then raised in unison and the hinge assemblies 100 are locked in the fully extended position. The climbers 14, 16 are then oriented so that the pairs of support arms 60, 61 straddle the tree 12. The platform is then rotated to a horizontal orientation, the pair of second support arms 61 are raised, and the hinge assemblies 100 are locked in the fully extended position. The hooking fingers 68 and the hooking sleeves 70 are joined to the hooking members 66, 64, respectively, so that the support arms 60, 61 for each climber 14, 16 are locked together, thus suspending both climbers 14, 16 from the tree 12.

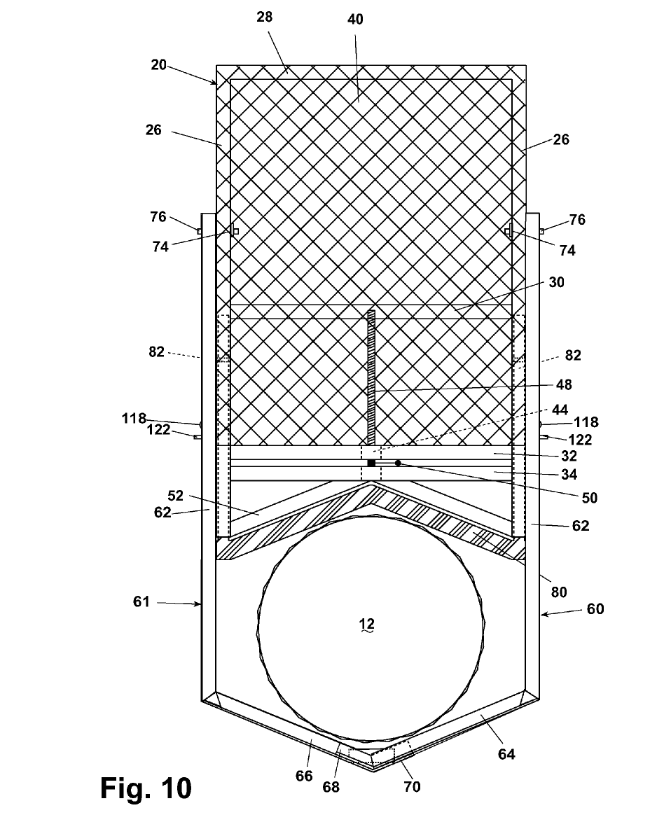

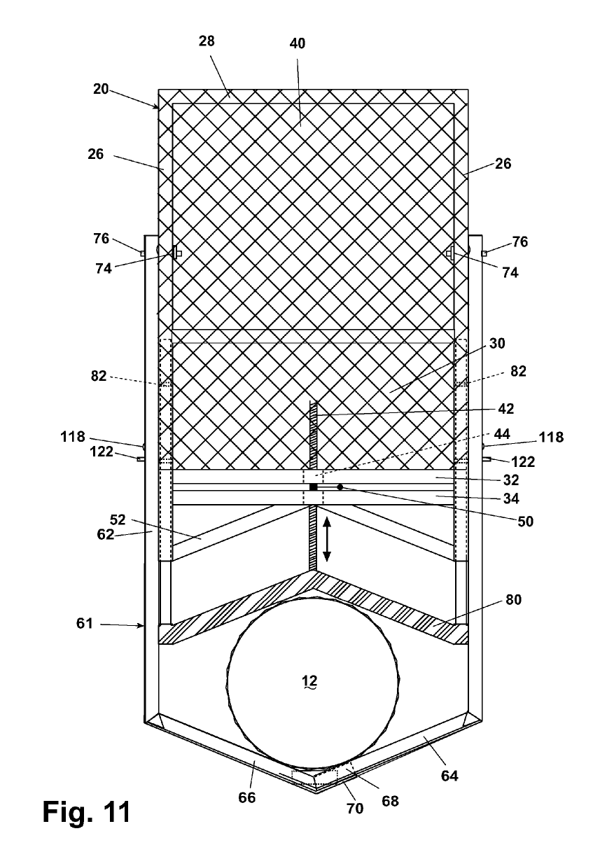

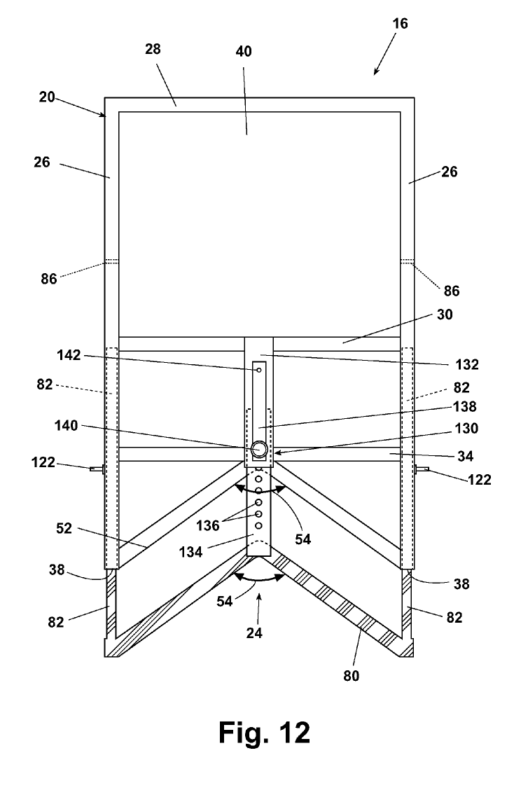

The attitude of the standing platform 14 can then be adjusted for the diameter of the tree 12 so that the floor frame 20 is suspended from the tree 12 at a selected attitude, such as horizontal. The adjustment of the attitude of the standing platform 14 is accomplished by operation of the ratchet assembly 44 to move the adjustment member 80 toward or away from the tree 12. FIG. 10 shows the attitude of the standing platform 14 adjusted for a tree 12 having a relatively large diameter. With a large-diameter tree, the adjustment member 80 is positioned adjacent to the V-cross frame member 52. FIG. 11 shows the attitude of the standing platform 14 adjusted for a tree 12 having a relatively small diameter. With a small-diameter tree, the adjustment member 80 is positioned away from the V-cross frame member 52. This adjustment is the same for both the standing platform 14 and the seat platform 16.

Once the tree stand 10 is suspended from the tree 12 at the desired height by “stepping” the tree stand 10 up the tree 12, the attitude of the standing platform 14 and the seat platform 16 can be individually adjusted to accommodate the hunter's preferences and any difference in diameter of the tree 12 that may exist. This can be readily done at any location on the tree 12, while the tree stand 10 is supporting the hunter, by operating the ratchet assembly 44 to move the adjustment member 80 inwardly or outwardly as desired, thereby individually adjusting the attitude of the standing platform 14 and the seat platform 16.

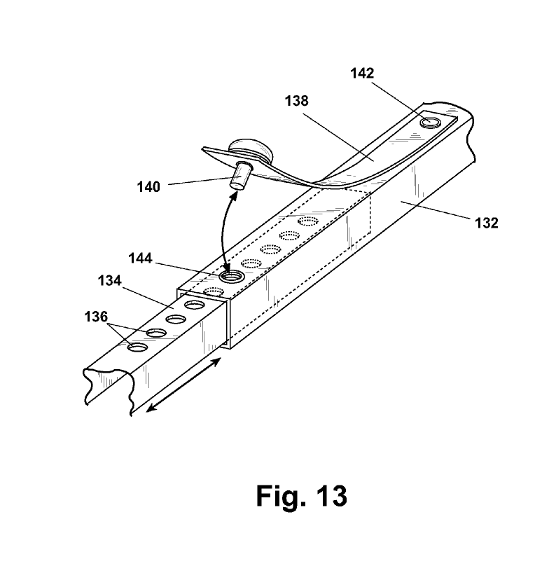

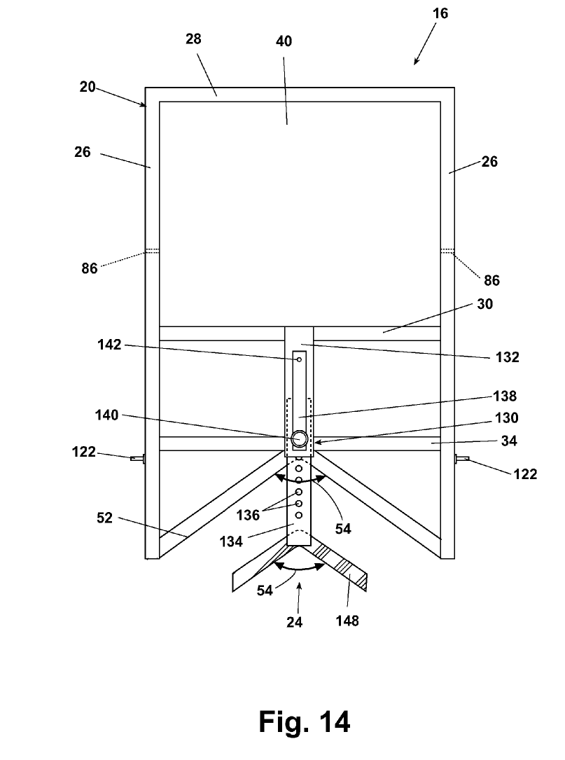

FIGS. 12 and 13 illustrate a second embodiment of a seat platform 128 in which the ratchet mechanism 44 and handle 50 of the first embodiment seat platform 16 are replaced by a pin adjustment mechanism 130. The second embodiment illustrated in FIGS. 12 and 13 shares many of the elements of the first embodiment illustrated in FIGS. 1-11 and, thus, like numbers are used to identify like elements. It will be recognized that only a standing platform portion without an arm assembly is illustrated in FIGS. 12 and 13, and that the arm assembly described for the first embodiment shown in FIGS. 1-11 will be attached to the seat platform portion shown in FIGS. 12 and 13 to provide the seat platform 128. Furthermore, while only the second embodiment seat platform 128 is illustrated, it is intended that the same inventive concept can be incorporated as well into a second embodiment standing platform in which the ratchet mechanism 44 and handle 50 of the first embodiment standing platform 14 are replaced by an identical pin adjustment mechanism 130.

As shown in FIG. 12, the pin adjustment mechanism 130 comprises a sleeve 132 into which a slide member 134 is slidably received. The sleeve 132 comprises a hollow tube-like member, such as square or round tubing, rigidly attached to the cross frame members 30, 34, in longitudinal alignment with a longitudinal axis of the seat platform 128. The slide member 134 comprises an elongated member, shown in FIG. 13 as a length of steel channel, adapted to be slidably received within the sleeve 132. Alternatively, the slide member 134 can comprise a length of square or round tubing, or angle iron, of suitable strength for the purposes described herein and adapted to be slidably received within the sleeve 132. The slide member 134 is rigidly attached at one end, such as by welding, to the vertex of the adjustment member 80. As shown in FIG. 13, the sleeve 132 is provided with a circular pin aperture 144 extending through an upper wall of the sleeve 132. The slide member 134 is preferably provided with a plurality of regularly-spaced circular pin seats 136 adapted for concentric alignment with the pin aperture 144.

A pin strap 138 comprises a thin strap of resiliently flexible material, such as spring steel, pivotably attached at a first end to the sleeve 132 using a pivotable connector 142, such as a rivet or a threaded connector. Preferably, the pin strap 138 comprises a material having an elastic limit of sufficient magnitude to accommodate deflection of the pin strap 138, as hereinafter described, without permanent deformation, and has a width of 1 inch and a length of 6 inches. A cylindrical pin 140 is fixedly attached at a second end to the pin strap 138 in concentric alignment with the pin aperture 144 and is adapted for slidable communication with the pin aperture 144. Preferably, the pin 140 has an enlarged head to facilitate grasping and pulling up on the pin 140 to remove the pin 140 from the pin aperture 144. The pin strap 138 will tend to retain the pin 140 in the pin aperture 144. However, the second end of the pin strap 138 and the pin 140 can be deflected upwardly by lifting up on the pin 140. Releasing the pin strap 138 will return the pin 140 to the pin aperture 144. The pin 140 will also slidably engage a pin seat 136 aligned with the pin aperture 144 to thereby retain the slide member 134 in position relative to the sleeve 132. The pivotable connector 142 enables the pin strap 138 to be pivoted about the pivotable connector 142 to thereby translate the pin 140 to either side of the sleeve 132 so that the slide member 134 can be adjusted relative to the sleeve 132 without having to maintain an upward deflection of the pin strap 138.

When the seat platform 128 is suspended at a desired location from the tree 12, the attitude of the seat platform 128 can be adjusted by removing the pin 140 from the pin aperture 144 and a pin seat 136 so that the slide member 134 can be moved inwardly or outwardly of the sleeve 132, thereby moving the adjustment member 80 toward or away from the tree 12. When the desired attitude of the seat platform 128 has been achieved, the pin 140 can be reinserted into the pin aperture 144 and a pin seat 136, thereby fixing the slide member 134 to the sleeve 132 and the adjustment member 80 against the tree 12. A similar operation can be performed for the standing platform. The pin strap 138 will retain the pin 140 in position in the pin aperture 144 and the pin seat 136, and will prevent the pin 140 from being misplaced or lost during transportation, storage, and use of the seat platform 128.

FIG. 14 shows a further embodiment of the pin adjustment mechanism 130 in which the adjustment member 80 is replaced with a V-shaped contact member 148, and the sliding arms 82 are omitted. The contact member 148 is a generally V-shaped member, similar to the adjustment member 80, of structural steel tubing having a rectilinear, preferably square, cross section of suitable structural properties for the purposes described herein. The vertex of the contact member 148 is oriented toward the inner cross frame member 34. The elimination of the sliding arms 82 enables the V-brace assembly 24 to be more readily adjusted relative to the floor frame 20 by eliminating the tendency of the sliding arms 82 to bind inside the side frame members 26.

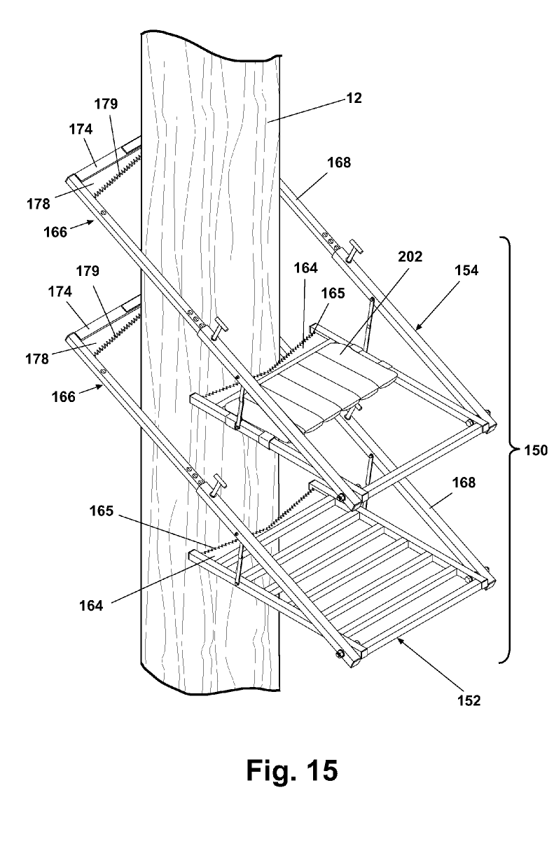

FIG. 15 shows a third embodiment of the adjustable hunting tree stand 150 comprising a standing platform 152 and a seat platform 154 suspended from a tree 12. The tree stand 150 is structurally and operationally similar in many respects to the tree stand 10.

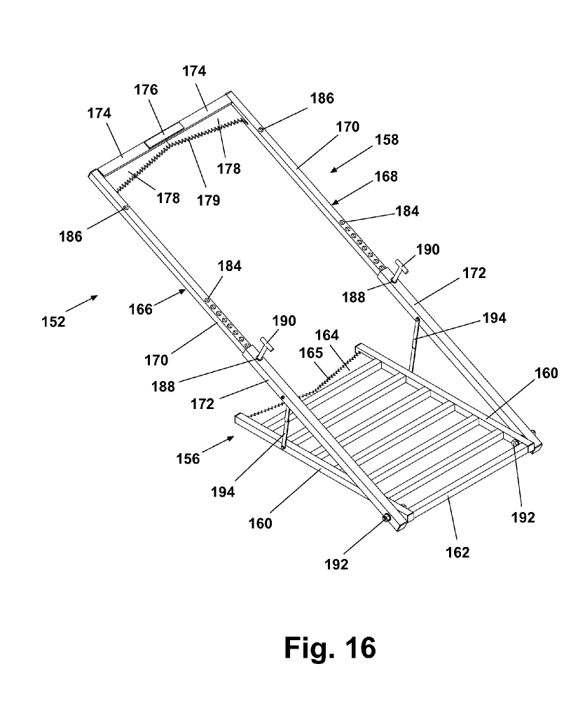

Referring also to FIG. 16, the standing platform 152 comprises a platform assembly 156 and a support arm assembly 158 pivotably attached thereto. The platform assembly 156 comprises a pair of elongated side rails 160 in parallel, spaced-apart juxtaposition. The side rails 160 are preferably fabricated of square structural steel tubing, but can comprise any material of suitable size and strength for the purposes described herein. The spacing between the side rails 160 is suitable for the comfortable support of a hunter, and can be selected to accommodate hunters of different sizes and weights.

Extending between the side rails 160 generally orthogonally thereto is a plurality of crosspieces 162, preferably of the same material and the same cross-sectional dimensions as the side rails 160. The length of the crosspieces 162 will correspond to the selected spacing between the side rails 160. The crosspieces 162 are rigidly attached to the side rails 160 in regular, spaced, parallel juxtaposition to form a platform assembly 156 suitable for supporting a standing hunter. The crosspieces 162 are attached to the side rails 160 through any suitable well-known means, such as welding, riveting, or the use of threaded fasteners, such as bolts or screws.

A first end of the platform assembly 156 terminates in V-shaped vee-brace 164, preferably in fixed communication with one of the crosspieces 162 to provide lateral support to the vee-brace 164. The vee-brace 164 comprises a serrated edge 165 opening away from the crosspieces 162 and adapted for piercing communication with the tree 12.

The support arm assembly 158 comprises a left support arm 166 and a right support arm 168 cooperatively adapted to encircle the tree 12. The support arms 166, 168 comprise an extension arm 170 and a sleeve 172. Both the extension arm 170 and the sleeve 172 comprise elongated members of suitable size and strength for the purposes described herein, preferably square structural steel tubing. The extension arm 170 is adapted to be slidably inserted in the sleeve 172 for shortening or lengthening the support arm 166, 168 as the extension arm 170 is inserted into or extended from the sleeve 172.

The sleeve 172 is provided at a first end with an extension pin aperture 188 extending therethrough, and is adapted at a second end to be pivotably connected to the platform assembly 156 through a suitable pivot connection 192, such as a bolted or riveted connection. Intermediate the pivot connection 192 and the extension pin aperture 188 the sleeve 172 is adapted for pivotable connection with a first end of a hinge 194, such as an articulated lid support hinge or lid stay. The second end of the hinge 194 is pivotably attached to the side rail 160 to enable the sleeve 172 to pivot between a first position adjacent and parallel to the side rail 160 and a second position inclined from the side rail 160 when the hinge is fully extended.

The extension arm 170 is provided at a first end with a plurality of extension apertures 184 therethrough adapted for coaxial alignment with the extension pin aperture 188. A pin 190 is adapted for insertion through the extension pin aperture 188 and an extension aperture 184 to retain the extension arm 170 in a selected extended position relative to the sleeve 172. Spaced somewhat away from the second end is a lock aperture 186 which is adapted for coaxial alignment with the extension pin aperture 188 when the extension arm 170 is fully inserted into the sleeve 172. FIGS. 15-19 show the extension apertures 184, the lock apertures 186, the extension pin apertures 188, and the pins 190 in a vertical orientation, i.e. through top and bottom walls of the extension arms 170 and the sleeves 172, when the hunting tree stand 150 is supported on a tree. Alternatively, the extension apertures 184, the lock apertures 186, the extension pin apertures 188, and the pins 190 can be oriented laterally, i.e. shifted 90 degrees, to extend through inner and outer side walls of the extension arms 170 and the sleeves 172.

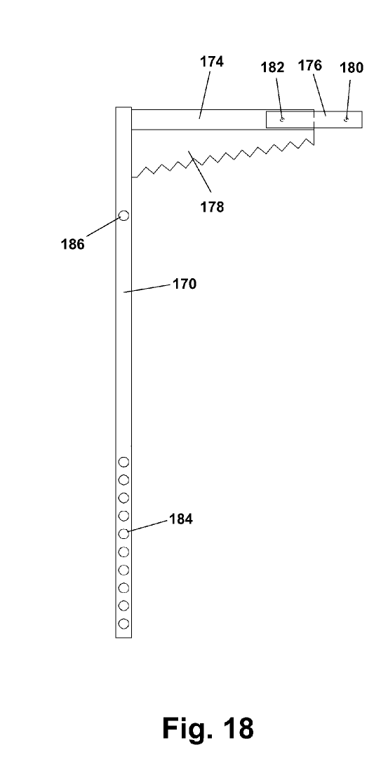

The extension arm 170 terminates at the second end in an end hook 174. The end hook 174 comprises square structural steel tubing having the same cross-sectional dimensions as the crosspieces 162 and a length approximately one-half the length of the crosspieces 162. The end hook 174 extends orthogonally inwardly from the extension arm 170 to terminate in a pin plate 176 extending from one wall of the tubing. A right triangle-shaped serrated brace 178 approximately equal in length to the end hook 174 is rigidly attached to the end hook 174 and the extension arm 170. The serrated brace 170 has an inclined serrated edge 179 facing toward the platform assembly 156 which is adapted for piercing communication with the tree 12. Referring also to FIG. 18, the pin plate 176 is provided with a pin 180 extending orthogonally therefrom. The end hook 174 is provided with a pin aperture 182 extending through the wall of the tubing opposite the pin plate 176, and adapted for slidable insertion of the pin 180.

The left support arm 166 and the right support arm 168 are identical in structure and configuration. The support arms 166, 168 are adapted so that the end hook 174 of each support arm 166, 168 will be placed in abutting relationship when the support arms 166, 168 are pivotably attached to the platform assembly 156 and the extension arms 170 are extended the same distance. However, the left support arm 166 is attached to the platform assembly 156 in an inverted manner relative to the right support arm 168 so that the pin plate 176 of the left support arm 166 is on the opposite side of the end hooks 174 than the pin plate 176 of the right support arm 168. As so configured, the pin 180 of each end hook 174 can be inserted into the pin aperture 182 of the other end hook 174 to lock the two support arms 166, 168 together. The serrated braces 178 will also be brought into an abutting relationship to form a vee-shaped brace similar in configuration to the vee-brace 164.

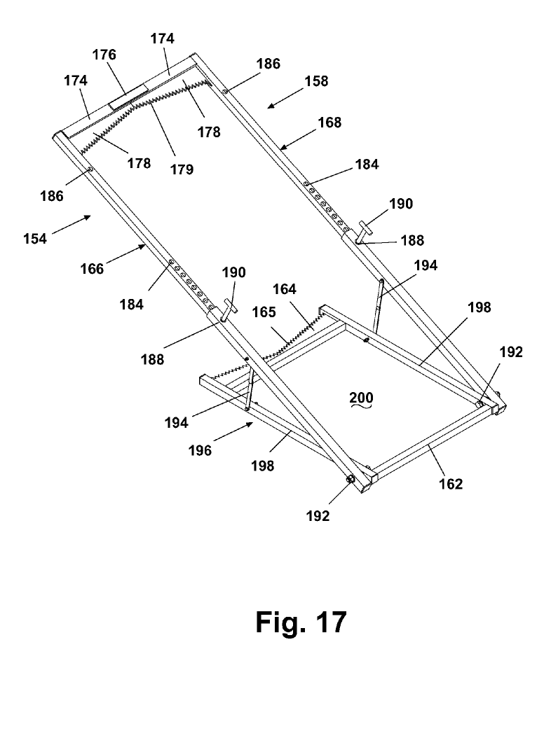

Referring now to FIG. 17, the seat platform 154 is identical to the standing platform 152 with the exception that the seat platform 154 comprises a seat frame 196 rather than a standing platform 152. The seat frame 196 comprises a pair of parallel, spaced-apart side rails 198 and a pair of parallel, spaced apart crosspieces 162 forming a generally rectilinear frame defining a rectilinear opening 200 therethrough. All other aspects of the seat platform 154 are identical to the standing platform 152. A seat 202, shown in FIG. 15, can be suspended between the side rails 198, and can comprise a rigid, semi-rigid, or cushion-like platform suitable for seating the hunter thereon. The seat 202 can be suspended between the side rails 198 through any suitable well-known means, such as straps with buckles or Velcro® closures.

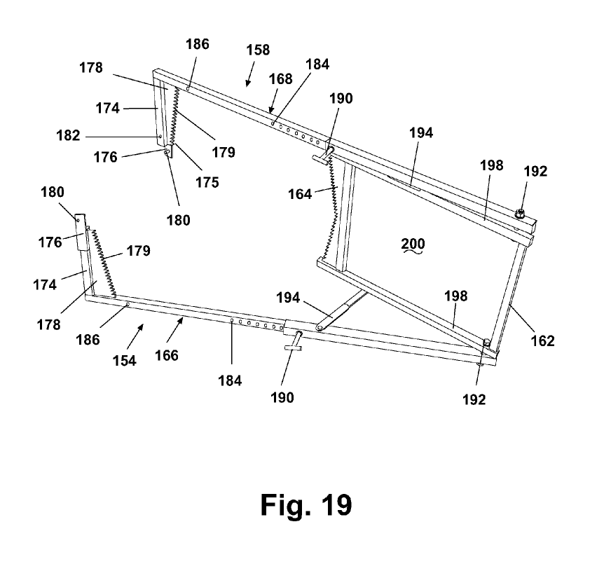

The tree stand 150 is used in a manner similar to the tree stand 10. Referring to FIG. 19, the tree stand 150 is suspended from the tree 12 by inclining one of the support arms (shown in FIG. 19 as the left support arm 166) away from the standing platform 152 or the seat platform 154 so that the tree 112 can be inserted between the support arms 166, 168 with the platform 152, 154 in a rotated orientation. The platform 152, 154 can then be rotated to its operational position while the second support arm is inclined and locked to the first support arm by inserting the pins 180 into the pin apertures 182 as previously described. The platform 152, 154 can be brought to a horizontal or other desired position by lengthening or shortening the support arms 166, 168 by removing the pins 190 and inserting or extending the extension arms 170 into or out of the sleeves 172. Replacing the pins 190 will secure the extension arms 170 to the sleeves 172, to enable the tree stand 150 to be “walked” up the tree 12 in a manner similar to that previously described with respect to the tree stand 10.

The novel tree stand 10 is similar in many respects to a conventional tree climber hunting stand, whose operation is well known in the industry. However, the novel tree stand 10 enables the ready adjustment of the attitude of the standing platform 14 and the seat platform 16, thereby improving the safety of such tree stands. Furthermore, the attitude adjustment does not require the hunter to adjust the support arms 60, 61 or an analogous structure, which frequently necessitates an adjustment on the side of the tree opposite the tree stand, thereby requiring the hunter to “hug” the tree and perform an operation without a clear view of the operation. The tree stand 10 is fully adjustable from a position on the floor frame 20, thereby significantly reducing the risk of a fall or failure of the tree stand 10. The novel tree stand 10 also is completely adjustable without the use of free pins, bolts, or other components that can become misplaced or lost.

While the invention has been specifically described in connection with certain specific embodiments thereof, it is to be understood that this is by way of illustration and not of limitation, and the scope of the appended claims should be construed as broadly as the prior art will permit.

1. An adjustable elevated hunting stand for supporting a person a spaced distance from the ground relative to a vertical structure, comprising:
a first platform comprising a first frame having a first member adapted for compressive register with the vertical structure, and at least one second member attached to the first frame and adapted for tensile register with the vertical structure;
a second platform comprising a second frame having a first member adapted for compressive register with the vertical structure, and at least one second member attached to the second frame and adapted for tensile register with the vertical structure;
at least one of the first and second platforms including an attitude adjuster interposed between the at least one of the first and second frames and the vertical structure, wherein the person can adjust the planar alignment of the at least one of the first and second frames relative to the vertical structure when the person is supported on the adjustable elevated hunting stand.

2. The adjustable elevated hunting stand of claim 1 wherein the first member is moveable relative to the at least one of the first and second frames.

3. The adjustable elevated hunting stand of claim 2 wherein the attitude adjuster comprises a ratchet for moving the first member relative to the at least one of the first and second frames.

4. The adjustable elevated hunting stand of claim 1 wherein the at least one second member comprises two support arms.

5. The adjustable elevated hunting stand of claim 4 wherein the two support arms extend around at least a portion of a perimeter of the vertical structure.

6. The adjustable elevated hunting stand of claim 5 wherein the two support arms are adapted for locking communication around at least a portion of the perimeter of the vertical structure.

7. The adjustable elevated hunting stand of claim 1 wherein the attitude adjuster comprises a telescoping portion comprising part of the at least one second member.

8. The adjustable elevated hunting stand of claim 1 wherein the at least one second member is pivotally attached to the at least one of the first and second frames.

9. An adjustable elevated hunting stand for supporting a person a spaced distance from the ground relative to a vertical structure, comprising:
a first platform adapted to support a person in a standing position;
a second platform adapted to support a person in a seated position;
at least one of the first and second platforms including an attitude adjuster interposed between the at least one of the first and second platforms and the vertical structure, wherein the person can adjust the planar alignment of the at least one of the first and second platforms relative to the vertical structure when the person is supported on the adjustable elevated hunting stand.

10. The adjustable elevated hunting stand of claim 9 wherein the attitude adjuster comprises a ratchet for moving at least one of the first and second platforms relative to the vertical structure.

11. The adjustable elevated hunting stand of claim 9 wherein the attitude adjuster comprises at least one member attached to the at least one of the first and second platforms and the vertical structure, and adapted for telescoping adjustment of the length of said at least one member.

12. An adjustable elevated hunting stand for supporting a person a spaced distance from the ground relative to a vertical structure, comprising:
at least one platform adapted for at least one of seated and standing support of a user when occupying the hunting stand the spaced distance from the ground relative to a vertical structure, the at least one platform comprising:
a first member having an inner surface adapted for compressive register with the vertical structure;
a second member having an inner surface adapted for tensile register with the vertical structure, wherein the inner surface of the first member and the inner surface of the second member cooperate to define a selectable distance therebetween;
an adjustable mounting between the first and second members, wherein the adjustable mounting between the first and second members allows for adjustment of the selectable distance between the respective inner surfaces;
whereby vertical structures having varying perimeters can be accommodated by selective adjustment of the selectable distance.

13. The adjustable elevated hunting stand of claim 12 wherein the at least one platform comprises a first platform adapted for seated support of a user when occupying the hunting stand and a second platform adapted for standing support of a user when occupying the hunting stand.

14. The adjustable elevated hunting stand of claim 13 wherein the first member is moveable relative to the second member.

15. The adjustable elevated hunting stand of claim 14 wherein the adjustable mounting between the first and second members comprises a ratchet for moving the first member relative to the second member.

16. The adjustable elevated hunting stand of claim 15 wherein the second member comprises two support arms.

17. The adjustable elevated hunting stand of claim 16 wherein the two support arms extend around at least a portion of a perimeter of the vertical structure.

18. The adjustable elevated hunting stand of claim 17 wherein the support arms are adapted for locking communication around at least a portion of the perimeter of the vertical structure.

19. The adjustable elevated hunting stand of claim 18 wherein the adjustable mounting comprises a telescoping portion wherein one of the first and second members is received within the other of the first and second members.

20. The adjustable elevated hunting stand of claim 19 wherein the at least one second member is pivotally attached to the first member.

21. The adjustable elevated hunting stand of claim 12 wherein the first member is moveable relative to the second member.

22. The adjustable elevated hunting stand of claim 12 wherein the adjustable mounting between the first and second members comprises a ratchet for moving the first member relative to the second member.

23. The adjustable elevated hunting stand of claim 12 wherein the second member comprises two support arms.

24. The adjustable elevated hunting stand of claim 23 wherein the two support arms extend around at least a portion of a perimeter of the vertical structure.

25. The adjustable elevated hunting stand of claim 23 wherein the support arms are adapted for locking communication around at least a portion of the perimeter of the vertical structure.

26. The adjustable elevated hunting stand of claim 12 wherein the adjustable mounting comprises a telescoping portion wherein one of the first and second members is received within the other of the first and second members.

27. The adjustable elevated hunting stand of claim 12 wherein the second member is mounted to the first member for pivotal movement with respect thereto.
